(19) United States
(12) Patent Application Publication
(10) Pub. No.: US 2026/0270764 A1
(43) Pub. Date: Sep. 10, 2026

(54) Radio Network Node, Network Node, and Methods Performed Therein in a Communications Network

(71) Applicant: Telefonaktiebolaget LM Ericsson (publ), Stockholm (SE)

(72) Inventors: Mohammed Yazid Lyazidi, Hässelby (SE); Nianshan Shi, Järfälla (SE); Paul Schliwa-Bertling, Ljungsbro (SE)

(21) Appl. No.: 19/166,631

(22) PCT Filed: Mar. 28, 2024
(86) PCT No.: PCT/SE2024/050293

§ 371 Date: Sep. 18, 2025

Related U.S. Application Data
(60) Provisional application No. 63/493,777, filed on Apr. 3, 2023.

(51) Int. Cl. H04W 28/02

(52) U.S. Cl. CPC H04W 28/0268

(57) ABSTRACT

Embodiments herein relate to, e.g., a method performed by a network node (16) for handling communication of a UE in a communication network. The network node (16) transmits to a radio network node (130), a message with one or more indications, wherein a first indication indicates one or more PDU Set QoS parameters, which can be used by the radio network node (130) to replace one or more current parameters received from another radio network node; and/or a second indication indicates a UE XR Traffic Characteristic to be used for scheduling.

### TECHNICAL FIELD

Embodiments herein relate to a network node, a radio network node, and methods performed therein regarding wireless communication. Furthermore, a computer program product and a computer readable storage medium are also provided herein. In particular, embodiments herein relate to handling communication of user equipments (UE) in a communication network.

### BACKGROUND

In a typical communication network, UEs, also known as wireless communication devices, mobile stations, stations (STA) and/or wireless devices, communicate via a Radio Access Network (RAN) with one or more core networks (CN). The RAN covers a geographical area which is divided into service areas or cells, with each service area or cell being served by a radio network node such as an access node e.g. a Wi-Fi access point or a radio base station (RBS), which in some networks may also be called, for example, a NodeB, a gNodeB, or an eNodeB. The service area or cell is a geographical area where radio coverage is provided by the radio network node. The radio network node operates on radio frequencies to communicate over an air interface with the UEs within range of the radio network node. The radio network node communicates over a downlink (DL) to the UE and the UE communicates over an uplink (UL) to the radio network node.

A Universal Mobile Telecommunications System (UMTS) is a third generation (3G) telecommunication network, which evolved from the second generation (2G) Global System for Mobile Communications (GSM). The UMTS terrestrial radio access network (UTRAN) is essentially a RAN using wideband code division multiple access (WCDMA) and/or High-Speed Packet Access (HSPA) for communication with user equipment. In a forum known as the Third Generation Partnership Project (3GPP), telecommunications suppliers propose and agree upon standards for present and future generation networks and investigate e.g. enhanced data rate and radio capacity. In some RANs, e.g. as in UMTS, several radio network nodes may be connected, e.g., by landlines or microwave, to a controller node, such as a radio network controller (RNC) or a base station controller (BSC), which supervises and coordinates various activities of the plural radio network nodes connected thereto. The RNCs are typically connected to one or more core networks.

Specifications for the Evolved Packet System (EPS) have been completed within the 3GPP and coming 3GPP releases, such as New Radio (NR), are worked on. The EPS comprises the Evolved Universal Terrestrial Radio Access Network (E-UTRAN), also known as the Long-Term Evolution (LTE) radio access network, and the Evolved Packet Core (EPC), also known as System Architecture Evolution (SAE) core network. E-UTRAN/LTE is a 3GPP radio access technology wherein the radio network nodes are directly connected to the EPC core network. As such, the Radio Access Network (RAN) of an EPS has an architecture comprising radio network nodes connected directly to one or more core networks.

With the emerging 5G technologies such as NR, the use of very many transmit- and receive-antenna elements may be of great interest as it makes it possible to utilize beamforming, such as transmit-side and receive-side beamforming. Transmit-side beamforming means that the transmitter can amplify the transmitted signals in a selected direction or directions, while suppressing the transmitted signals in other directions. Similarly, on the receive-side, a receiver can amplify signals from a selected direction or directions, while suppressing unwanted signals from other directions. NR is connected to the 5G Core Network (5 GC) which comprises a number of Network Functions (NF) such as Session Management Function (SMF), Access Management Function (AMF), Authentication Service Function (AUSF), Policy Control Function (PCF), Unified Data Manager (UDM), Network Repository Function (NRF), Network Exposure Function (NEF), just to mention some. In the 5GC, NFs can discover other NFs by using a discovery service provided by the Network Repository Function (NRF).

Augmented reality (AR) may be defined as an interactive experience that combines the real world and computer-generated content. The computer-generated content can span multiple sensory modalities, including visual, auditory, haptic, somatosensory and olfactory. AR can be defined as a system that incorporates three basic features: a combination of real and virtual worlds, a real-time interaction, and an accurate three dimensional (3D) registration of virtual and real objects.

In addition to the “AR” term, the industry uses two other related terms. Mixed reality (MR) is an advanced form of AR where some virtual elements are inserted into the physical scene with the intent to provide the illusion that these elements are part of the real scene. Extended reality (XR) refers to all real-and-virtual combined environments and human-machine interactions generated by computer technology and wearables. It includes representative forms such as AR, MR and virtual reality (VR) and the areas interpolated among them. The levels of virtuality range from partially sensory inputs to fully immersive VR. A key aspect of XR is the extension of human experiences especially relating to the senses of existence, represented by VR, and the acquisition of cognition, represented by AR.

While it is herein mostly used the “XR” term in the description but “MR” and “AR” may equally be applied to embodiments herein.

In 3GPP, the working group (WG) System Architecture 2 (SA2) has concluded in the study item: “Study on XR (Extended Reality) and media services” for Rel-18 in TR 23.700-60v1.3.0 that:

```
″ The following information, to be provided to the NG-RAN at PDU Session Establishment/Modification via
an NGAP Message, is taken as baseline for normative work:
  -Periodicity for UL and DL traffic of the QoS Flow. In addition to integer periodicity values, non-integer
    values associated to, e.g. 15 FPS, 30 FPS, 45FPS, 60 FPS, 72 FPS, 90FPS, 120FPS, shall be supported.
    Such information shall be exchanged by re-using/extending the TSCAI/TSCAC definitions in
    clause 5.27.2.1 of TS 23.501 [2].
```

| | |
|---|---|
| a | NOTE 1: The above information can be provided to the 5GC by the AF via an NEF API. The |
| | 5GC can further derive, or be configured, with such information. |

```
  -Traffic jitter information (e.g. jitter range) associated with each periodicity. The SMF requests the UPF to
    derive jitter (i.e. N6 jitter) for a given periodicity. 5GC derives jitter information accordingly and
    forwards it to the RAN along with periodicity.
  NOTE 2: How the UPF derives the jitter is left for implementation. How the SMF obtains and
    provides the jitter information will be defined in the normative phase.”
```

In addition, the RAN2 WG has in the study item: “Study on XR enhancements for NR” for Rel-18 accepted the SA2 conclusions and stated the following in TR 38.835 v.2.0.0:

″Delivery of some assistance information (e.g. periodicity) reusing TSCAI as a baseline. Whether additional
mechanism is required can be further considered with an assumption that all information may not be always
available at UE application.”

Furthermore, a new XR WID was approved in RP-230786, where the following objectives are listed:

Specify the enhancements for XR Awareness:

| | |
|---|---|
| - | Signalling by CN of semi-static information per QoS flow (e.g. PDU set QoS parameters), dynamic |
| | information per PDU set (PDU Set information and Identification) and End of Data Burst indication |
| | (RAN3, RAN2); |
| - | Impact of identifying by UE of PDU Sets, Data bursts and PSI, as needed (RAN2); |
| - | Provisioning by UE of XR traffic assistance information e.g. periodicity, UL traffic arrival information |
| | (RAN2, RAN3); |
| - | Support signalling the congestion information from RAN to the CN in alignment with SA2 (RAN3); |

The highlighted above text is most relevant.

The term protocol data unit (PDU) Set has been defined by 3GPP working group SA2 in TR 23.700-60, Study on XR (Extended Reality) and media services Rel 18, and accepted by RAN2 in TR 38.835, Study on XR enhancements for NR, and is defined as:

PDU Set: A PDU Set is composed of one or more PDUs carrying the payload of one unit of information
generated at the application level (e.g., a frame or video slice for XRM Services, as used in TR 26.926 [6]). In
some implementations all PDUs in a PDU Set are needed by the application layer to use the corresponding
unit of information. In other implementations, the application layer can still recover parts or all of the
information unit, when some PDUs are missing.

### SUMMARY

As part of developing embodiments herein one or more problems have been identified. During Xn based handover and handover request during N2 based handover between AMF and NG-RAN, the target NG-RAN performs admission control rejecting any quality of service (QoS) flows for which resources cannot be permanently allocated. The accepted QoS flows are included in the N2 Path Switch Request or N2 handover request acknowledge message from the NG-RAN to the AMF.

In the case of PDU Set and XR, it is not possible to update the CN about the currently supported and fulfilled PDU Set QoS parameters for the accepted QoS flows. The design for supporting PDU Set QoS parameters after mobility between RAN and 5GCN is missing, especially when it comes to support of XR during mobility procedures.

Furthermore, after a mobility event the CN cannot update the new NG-RAN node on the supported XR traffic assistance information, e.g., periodicity, jitter. Without such information, the new RAN cannot know how to coordinate and schedule the UE's resources for XR.

An object of embodiments herein is to improve performance of a UE in a communication network.

According to an aspect the object is achieved, according to some embodiments herein, by providing a method performed by a network node, such as an AMF, for handling communication of a UE in a communication network. The network node transmits to a radio network node, a message with one or more indications, wherein a first indication indicates one or more PDU Set QoS parameters which can be used by the radio network node to replace one or more current parameters received from another radio network node; and/or a second indication indicates a UE XR Traffic Characteristic to be used for scheduling.

According to another aspect the object is achieved, according to some embodiments herein, by providing a method performed by a radio network node, such as an gNB, for handling communication of a UE in a communication network. The radio network node receives from a network node, a message with one or more indications, wherein a first indication indicates one or more PDU Set QoS parameters which can be used by the radio network node to replace one or more current parameters received from another radio network node; and/or a second indication indicates a UE XR Traffic Characteristic to be used for scheduling. The radio network node may transmit an indication to a network node such as an AMF, wherein the indication indicates supported PDU Set QoS parameter.

It is furthermore provided herein a computer program product comprising instructions, which, when executed on at least one processor, cause the at least one processor to carry out the methods herein, as performed by the radio network node and the network node, respectively. It is additionally provided herein a computer-readable storage medium, having stored thereon a computer program product comprising instructions which, when executed on at least one processor, cause the at least one processor to carry out the method according to the methods herein, as performed by the radio network node and the network node, respectively.

Furthermore, according to another aspect the object is achieved, according to some embodiments herein, by providing a network node and a radio network node configured to perform the methods herein, respectively.

According to an aspect the object is achieved, according to some embodiments herein, by providing a network node, such as an AMF, for handling communication of a UE in a communication network. The network node is configured to transmit to a radio network node, a message with one or more indications, wherein a first indication indicates one or more PDU Set QoS parameters which can be used by the radio network node to replace one or more current parameters received from another radio network node; and/or a second indication indicates a UE XR Traffic Characteristic to be used for scheduling.

According to another aspect the object is achieved, according to some embodiments herein, by providing a radio network node, such as an gNB, for handling communication of a UE in a communication network. The radio network node is configured to receive from a network node, a message with one or more indications, wherein a first indication indicates one or more PDU Set QoS parameters which can be used by the radio network node to replace one or more current parameters received from another radio network node; and/or a second indication indicates a UE XR Traffic Characteristic to be used for scheduling.

It is proposed herein to enable CN, i.e., the network node, to inform the radio network node such as a target gNB, following a mobility event (Xn based or NG based) about the PDU Set QoS parameters to use for admission control, that will replace the ones sent by a source gNB. One may also or alternatively indicate the UE XR Traffic characteristics in, for example, the Path Switch Request Acknowledge message.

Embodiments herein allow a negotiation procedure between RAN and CN on the support PDU Set QoS parameters to be used during handover admission control, and/or allow for XR awareness at a radio network node, for example, a new gNB following a mobility event. This will thus result in an improved performance at the UE in the communication network.

### BRIEF DESCRIPTION OF THE DRAWINGS

Embodiments will now be described in more detail in relation to the enclosed drawings, in which:

FIG. 1 shows an overview depicting a communication network according to embodiments herein;

FIG. 2 is a combined flowchart and signalling scheme according to embodiments herein;

FIG. 3 shows a flowchart illustrating a method performed by a network node according to embodiments herein;

FIG. 4 shows a flowchart illustrating a method performed by a radio network node according to embodiments herein;

FIG. 5 shows a block diagram depicting embodiments of a network node according to embodiments herein;

FIG. 6 shows a block diagram depicting embodiments of a radio network node according to embodiments herein;

FIG. 7 schematically illustrates a telecommunication network connected via an intermediate network to a host computer;

FIG. 8 is a generalized block diagram of a host computer communicating via a base station with a user equipment over a partially wireless connection; and

FIGS. 9, 10, 11, and 12 are flowcharts illustrating methods implemented in a communication system including a host computer, a base station and a user equipment.

### DETAILED DESCRIPTION

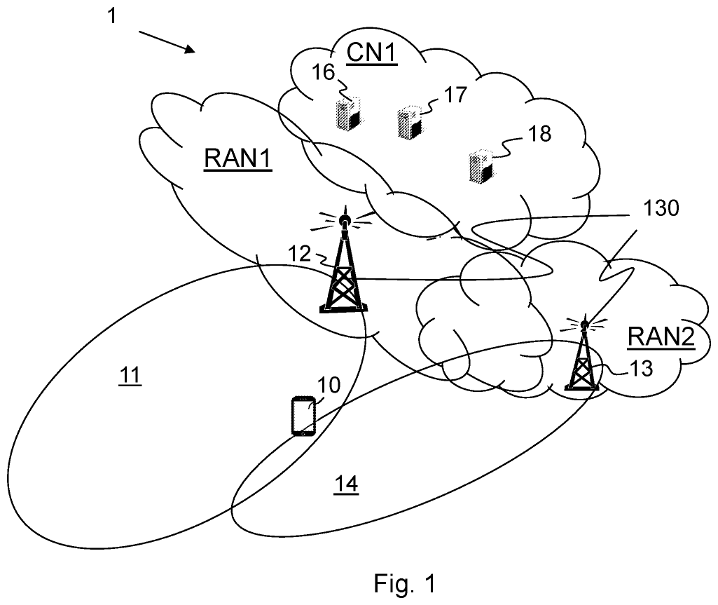

Embodiments herein relate to communication networks in general. FIG. 1 is a schematic overview depicting a communication network 1. The communication network 1 comprises one or more RANs and one or more CNs. The communication network 1 may use one or a number of different technologies. Embodiments herein relate to recent technology trends that are of particular interest in a New Radio (NR) context, however, embodiments are also applicable in further development of existing wireless communications systems such as e.g. LTE or Wideband Code Division Multiple Access (WCDMA).

In the communication network 1, a user equipment (UE) 10 exemplified herein as a wireless device such as a mobile station, a non-access point (non-AP) station (STA), a STA and/or a wireless terminal, is comprised communicating via e.g. one or more Access Networks (AN), e.g. radio access network (RAN), to one or more core networks (CN). It should be understood by the skilled in the art that “UE” is a non-limiting term which means any terminal, wireless communications terminal, user equipment, narrowband internet of things (NB-IoT) device, Machine Type Communication (MTC) device, Device to Device (D2D) terminal, or node e.g. smart phone, laptop, mobile phone, sensor, relay, mobile tablets or even a small base station capable of communicating using radio communication with a radio network node within an area served by the radio network node.

The communication network 1 comprises a first radio network node 12 or just radio network node, providing radio coverage over a geographical area, a first service area 11 or first cell, of a first radio access technology (RAT), such as NR, LTE, or similar. The radio network node 12 may be a transmission and reception point such as an access node, an access controller, a base station, e.g. a radio base station such as a gNodeB (gNB), an evolved Node B (eNB, eNode B), a NodeB, a base transceiver station, a radio remote unit, an Access Point Base Station, a base station router, a Wireless Local Area Network (WLAN) access point or an Access Point Station (AP STA), a transmission arrangement of a radio base station, a stand-alone access point or any other network unit or node capable of communicating with a UE within the area served by the first radio network node depending e.g. on the first radio access technology and terminology used. The first radio network node may be referred to as a serving radio network node wherein the service area may be referred to as a serving cell, and the serving network node communicates with the wireless device in form of DL transmissions to the wireless device and UL transmissions from the wireless device. It should be noted that a service area may be denoted as cell, beam, beam group or similar to define an area of radio coverage.

The communication network 1 comprises a second radio network node 13 or just radio network node, providing radio coverage over a geographical area, a second service area 14 or second cell, of a second radio access technology (RAT), such as NR, LTE, or similar. The second radio network node 13 may be a transmission and reception point such as an access node, an access controller, a base station, e.g. a radio base station such as a gNodeB (gNB), an evolved Node B (eNB, eNode B), a NodeB, a base transceiver station, a radio remote unit, an Access Point Base Station, a base station router, a Wireless Local Area Network (WLAN) access point or an Access Point Station (AP STA), a transmission arrangement of a radio base station, a stand-alone access point or any other network unit or node capable of communicating with a wireless device within the area served by the second radio network node depending e.g. on the first radio access technology and terminology used. The second radio network node 13 may be referred to as a visiting radio network node or target radio network node, wherein the service area may be referred to as a visiting cell or target cell, and the second radio network node communicates with the UE in form of DL transmissions to the UE and UL transmissions from the UE. It should be noted that a service area may be denoted as cell, beam, beam group or similar to define an area of radio coverage.

The first RAT may be the same RAT as the second RAT or the first RAT may be a different RAT than the second RAT.

The communication network 1 may further comprise a number of core network nodes providing, e.g. in NR, network functions (NF) or actually instantiations of NFs also referred to as NF instances, such as a first network node 16, also referred to as network node 16, providing, for example, an instantiation of an AMF or SMF, a second network node 17 providing an instantiation of a NRF, and a third network node 18 providing, for example, an instantiation of an PCF, or any other NF instances in the communication network 1. The different NF instances may have different tasks. Other functions may be for LTE such as MME or similar.

The respective node may be a standalone server, a cloud-implemented server, a distributed server or processing resources in a server farm or same node. Embodiments herein may be implemented as physical bare metal, virtual or cloud native such as Kubernetes environment in e.g. hyper-cloud networks.

The network node 16 transmits to a radio network node 130 such as the second radio network node 13 or the first radio network node 12, a message with one or more indications, wherein a first indication indicates one or more PDU Set QoS parameters which can be used by the second radio network node 13 to replace one or more current parameters received from the first radio network node 12; and/or a second indication that indicates a UE XR Traffic Characteristic to be used for scheduling.

In case the radio network node 130 cannot support the one or more indicated PDU Set QoS parameters, e.g., PDU Set Delay Budget (PSDB), the radio network node 130 may indicate the ones currently supported in the PDU SESSION RESOURCE NOTIFY message.

Embodiments herein may add one or more parameters in NGAP signalling:

From the radio network node 130 to the network node 16, NG-RAN node→5GCN:
In the PDU SESSION RESOURCE NOTIFY message, the radio network node 130 may indicate the supported PDU Set QoS parameter, e.g. PDU Set Delay Budget for UL and DL, to notify the network node 16, such as an AMF, of the currently accepted parameters.
In the NGAP signalling, e.g., PATH SWITCH REQUEST message, a flag such as a PDU Set information support flag is included by the radio network node 130 to indicate to network node 16 such as an SMF after Xn HandOver from a non-supporting radio network node.

From the network node 16 to the radio network node 130; 5GCN→NG-RAN node:
In the NGAP signalling, e.g., PDU Resource Setup procedure, a PDU Set information support flag is signalled to indicate that the PDU Resource setup procedure supports PDU Set handling. If supported, the radio network node 130 replies with an acknowledgment message.
In the PATH SWITCH REQUEST ACKNOWLEDGE message, the network node 16 such as AMF, indicates the PDU Set QoS parameters which can be used by the new radio network node 130 to replace the parameters received by the other radio network node such as a source NG-RAN.
In the PATH SWITCH REQUEST ACKNOWLEDGE message, the network node 16 such as AMF, may indicate the UE XR Traffic Characteristics such as periodicity, jitter and burst arrival in time to be used for scheduling.

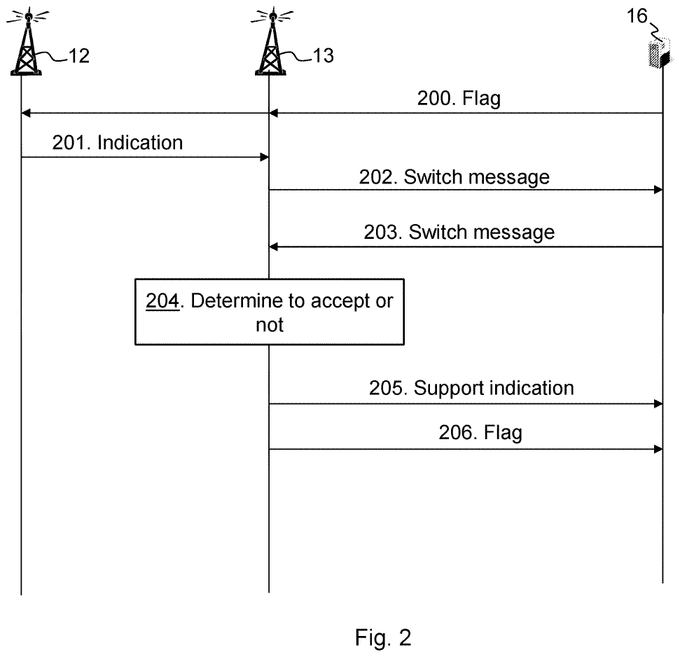

FIG. 2 is a combined flow chart and signalling scheme according to some embodiments herein.

Action 200. The network node 16 may transmit a flag to the radio network node 130, such as the first radio network node 12 and/or the second network node 13, during a PDU Session setup procedure to indicate support of PDU Set handling. In case of support the radio network node 130 may reply with an acknowledgement message.

Action 201. The first radio network node 12 may transmit, during handover, an indication that indicates one or more PDU Set QoS parameters to be used by the second radio network node 13. The indication may be transmitted over Xn signalling during an Xn-based handover, or over NG signalling during a NG-based handover procedure.

Action 202. The second radio network node 13 may send a switch message, such as a N2 PATH SWITCH REQUEST message, to the network node 16, such as the AMF, to establish a UE associated signalling connection to the 5GC. The switch message may further indicate one or more accepted XR QoS flows.

Action 203. The network node 16 signals to the second radio network node 13 in a switch message such as a PATH SWITCH REQUEST ACKNOWLEDGE message, with the one or more indications, such as the first indication of the one or more PDU Set QoS parameters to use for the one or more accepted XR QoS flows.

The network node 16 may also, or alternatively, signal the second indication indicating the one or more UE XR Traffic Characteristics to the second radio network node 13. These UE XR Traffic characteristics may include the periodicity and jitter information that should be used by the second radio network node 13 for the purpose of scheduling.

Action 204. The second radio network node 13 may determine whether to accept or not the indicated one or more PDU Set QoS parameters. When one or more PDU Set QoS related parameters are not accepted by the second radio network node 13, the second radio network node 13 uses one or more previous PDU Set QoS parameters values received from the first radio network node 12, if any.

Action 205. The second radio network node 13 transmits a support indication to the network node 16, wherein the support indication indicates supported PDU Set QoS parameter. The second radio network node 13 may signal, e.g. in Path Switch Request, that it does or does not accept the one or more PDU Sets QoS parameters via PATH SWITCH REQUEST ACKNOWLEDGE. In one embodiment, the second radio network node 13 may signal the used PDU Set QoS parameters values in the PDU SESSION RESOURCE NOTIFY message to notify the network node 16.

Action 206. The second radio network node 13 may transmit a flag to the network node 16 following a handover (HO) from a non-supporting radio network node, in, e.g., the PAT SWITCH REQUEST procedure. Upon reception of the flag, the network node 16 may consider that the QoS flow that are accepted are subject to PDU Set QoS handling and that the handover was done from a non supporting source radio network node.

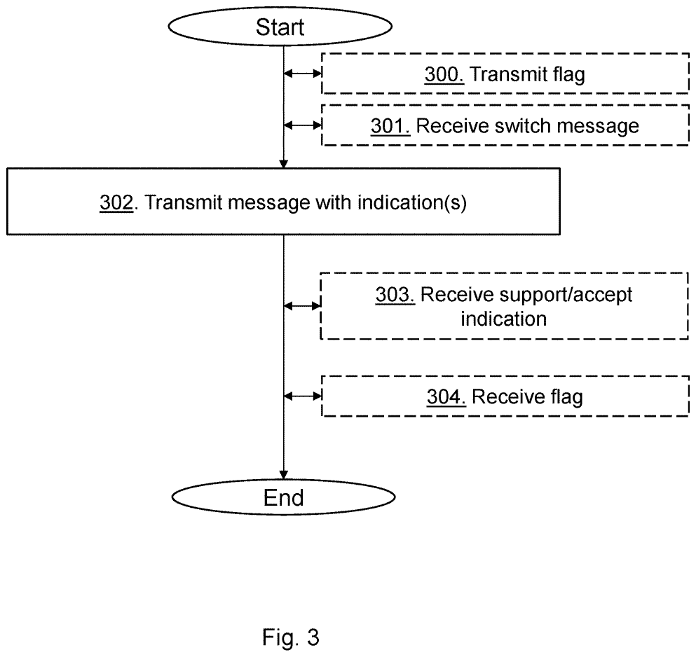

The method actions performed by the network node 16, such as the AMF or the SMF, for handling communication of the UE 10 in the communication network, for example, handling a session, according to embodiments herein will now be described with reference to a flowchart depicted in FIG. 3. The actions do not have to be taken in the order stated below, but may be taken in any suitable order. Actions performed in some embodiments are marked with dashed boxes.

Action 300. The network node 16 may transmit the flag to the radio network node 130, such as the first radio network node 12 or the second radio network node 13, during a PDU Session setup procedure to indicate support of PDU Set handling.

Action 301. The network node 16 may receive the switch message, such as a N2 PATH SWITCH REQUEST message, from the second radio network node 13 to establish a UE associated signalling connection to the 5GC. The switch message may further indicate one or more accepted XR QoS flows.

Action 302. The network node 16 transmits to the radio network node 130, the message with the one or more indications, wherein the first indication indicates one or more PDU Set QoS parameters which can be used by the radio network node 130 to replace one or more current parameters received from another radio network node; and/or the second indication indicates the UE XR Traffic Characteristic to be used for scheduling. For example, the network node 16 may transmit to the second radio network node 13 in a switch message such as a PATH SWITCH REQUEST ACKNOWLEDGE message, the first indication of one or more PDU Set QoS parameters to use for the one or more accepted XR QoS flows. The one or more PDU Set QoS parameters may comprise PDU Set Delay Budget for UL and DL, PDU Set Error rate, and/or PDU Set Integration indication. Additionally or alternatively, the network node 16 may signal the second indication indicating UE XR Traffic Characteristics to the second radio network node 13. The UE XR Traffic Characteristics may include a periodicity and/or a jitter information that should be used by the second radio network node 13 for the purpose of scheduling.

Action 303. The network node 16 may receive the support indication from the second radio network node 13, wherein the support indication indicates supported PDU Set QoS parameter at the second radio network node 13. Additionally, or alternatively, the network node 12 may receive, e.g. in Path Switch Request, an accept indication that the radio network node 130 does or does not accept the one or more PDU Sets QoS parameters.

Action 304. The network node 16 may receive the flag from the radio network node 130 following a HO from a non-supporting gNB, in, e.g., the PATH SWITCH REQUEST procedure. Upon reception of the flag, the network node 16 may consider that the QoS flow that is accepted is subject to PDU Set QoS handling and that the handover was done from a non supporting radio network node.

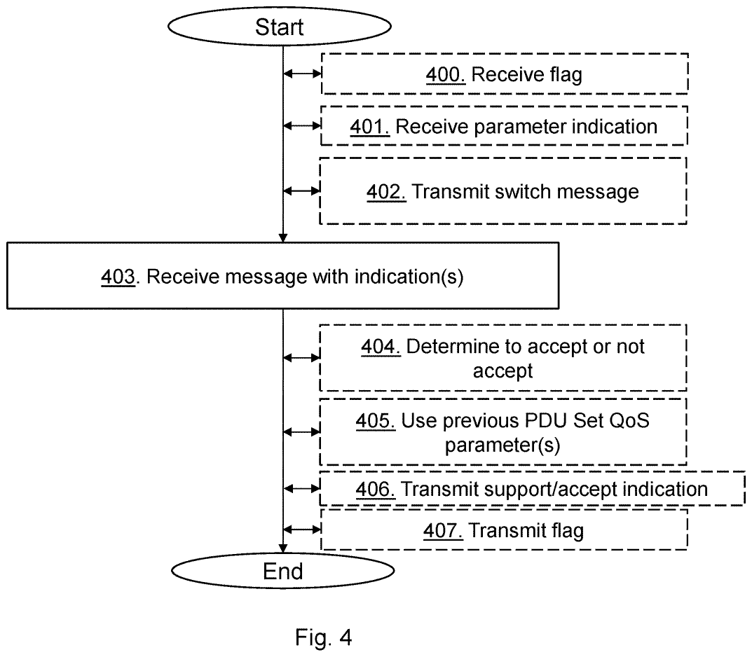

The method actions performed by the radio network node 130, such as the second radio network node 13 and/or the first radio network node 12, for handling communication of the UE 10 in the communication network, for example, handling a session, according to embodiments herein will now be described with reference to a flowchart depicted in FIG. 4. The actions do not have to be taken in the order stated below, but may be taken in any suitable order. Actions performed in some embodiments are marked with dashed boxes.

Action 400. The radio network node 130 may receive the flag from the network node 16 during the PDU Session setup procedure to indicate support of PDU Set handling. In case of support the radio network node 130 may reply with an acknowledgement message.

Action 401. The radio network node 130 may receive, during handover of the UE 10, a parameter indication that indicates one or more PDU Set QoS parameters to be used by the radio network node 130. The parameter indication may be transmitted over Xn signalling during a Xn-based handover, or over NG signalling during a NG-based Handover procedure.

Action 402. The radio network node 130 may transmit to the network node 16 the switch message, such as the N2 PATH SWITCH REQUEST message, to establish a UE associated signalling connection to the 5GC. The switch message may further indicate one or more accepted XR QoS flows.

Action 403. The radio network node 130 receives from the network node 16, the message with the one or more indications, wherein the first indication indicates one or more PDU Set QoS parameters which can be used by the radio network node 130 to replace one or more current parameters received from another radio network node; and/or the second indication indicates the UE XR Traffic Characteristic to be used for scheduling. As an example, the radio network node 130 may receive from the network node 16 in the switch message, such as the PATH SWITCH REQUEST ACKNOWLEDGE message, the one or more indications of one or more PDU Set QoS parameters to use for the one or more accepted XR QoS flows. The one or more PDU Set QoS parameters may comprise PDU Set Delay Budget for UL and DL, PDU Set Error rate, and/or PDU Set Integration indication. Additionally, or alternatively, the radio network node 130 may receive from the network node 16 UE XR Traffic Characteristics. The UE XR Traffic Characteristics may include a periodicity and/or a jitter information that should be used by the radio network node 130 for the purpose of scheduling.

Action 404. The radio network node 130 may determine whether to accept or not accept the indicated one or more PDU Set QoS parameters.

Action 405. When one or more PDU Set QoS related parameters are not accepted by the radio network node 130, the radio network node 130 may use one or more previous PDU Set QoS parameters values received from the first radio network node 12.

Action 406. The radio network node 130 may transmit the support indication to the network node 16, wherein the support indication indicates supported PDU Set QoS parameter. The radio network node 130 may transmit or signal, e.g. in Path Switch Request, the accept indication that the radio network node 130 does or does not accept the one or more PDU Sets QoS parameters via PATH SWITCH REQUEST ACKNOWLEDGE. The radio network node 130 may signal the used PDU Set QoS parameters values in the PDU SESSION RESOURCE NOTIFY message to notify the network node 16.

Action 407. The radio network node 130 may transmit the flag to the network node 16 following a HO from a non-supporting radio network node, in, e.g., the PATH SWITCH REQUEST procedure.

### According to One or More Embodiments

In embodiments herein the source NG-RAN node, i.e., the first radio network node 12, may indicate the PDU Set QoS parameters to be used by the target gNB, i.e., the second radio network node 13, during handover. The parameter indication may be over Xn signalling during the Xn-based handover, or over NG signalling during the NG-based Handover procedure.

In one embodiment, upon receiving the parameter indication of the PDU Set QoS parameters from the first radio network node 12 and performing admission control, the second radio network node 13 may send a N2 PATH SWITCH REQUEST message to the network node 16 such as the AMF to establish a UE associated signalling connection to the 5GC and indicating the list of accepted QoS flows that are associated with XR and that support PDU Set.

In one embodiment, the network node 16 signals to the second radio network node 13 in the PATH SWITCH REQUEST ACKNOWLEDGE message, the first indication of the PDU Set QoS parameters to use for the accepted XR QoS flows.

The network node 16 may also, or alternatively, signal the second indication indicating the UE XR Traffic Characteristics to the second radio network node 13. These UE XR Traffic characteristics may include the periodicity and jitter information that should be used by the second radio network node 13 for the purpose of scheduling.

In one embodiment, if the PDU Set QoS related parameters, e.g., PDU Set Delay Budget for UL and DL, PDU Set Error rate and PDU Set Integration indication, are included in the PATH SWITCH REQUEST ACKNOWLEDGE message, but cannot be successfully accepted by the second radio network node 13, the second radio network node 13 may use the previous PDU Set QoS parameters values received from the first radio network node 12, if any. In one embodiment, the second radio network node 13 signals the used PDU Set QoS parameters values in the PDU SESSION RESOURCE NOTIFY message to notify the network node 16.

In one embodiment, the second radio network node 13 may signal, e.g. in Path Switch Request that it does or does not accept the PDU Sets QoS parameters via PATH SWITCH REQUEST ACKNOWLEDGE.

In one embodiment, a flag such as a PDU Set information support flag indication is signaled to the radio network node 130 from 5GCN during the PDU Session setup procedure to indicate the support of PDU Set handling. In case of support the radio network node 130 may reply with an acknowledgement message.

In one embodiment, a PDU Set information support flag indication is signalled by the second network node 13, such as a target gNB, following Xn HO from a non-supporting radio network node to 5GCN, in, e.g., the PATH SWITCH REQUEST procedure. Upon reception of the flag, the network node 16 considers the QoS flow that are accepted are subject to PDU Set QoS handling and that the handover was done from a non supporting source gNB.

Below are possible impacts to NGAP TS 38.413 v17.3.0, where the new additions are underlined and bold

### 9.2.3.9 PATH SWITCH REQUEST ACKNOWLEDGE

This message is sent by the AMF to inform the NG-RAN node that the path switch has been successfully completed in the 5GC.

Direction: AMF→NG-RAN node.

| | | | IE type and | Semantics | | Assigned |
|---|---|---|---|---|---|---|
| IE/Group Name | Presence | Range | reference | description | Criticality | Criticality |
| Message Type | M | | 9.3.1.1 | | YES | reject |
| AMF UE NGAP ID | M | | 9.3.3.1 | | YES | ignore |
| RAN UE NGAP ID | M | | 9.3.3.2 | | YES | ignore |
| UE Security | O | | 9.3.1.86 | | YES | reject |
| Capabilities | | | | | | |
| Security Context | M | | 9.3.1.88 | | YES | reject |
| New Security Context | O | | 9.3.1.55 | | YES | reject |
| Indicator | | | | | | |
| PDU Session | | 1 | | | YES | ignore |
| Resource Switched | | | | | | |
| List | | | | | | |
| >PDU Session | | 1 . . . | | | — | |
| Resource Switched | | <maxnoofPDUSessions> | | | | |
| Item | | | | | | |
| >>PDU Session ID | M | | 9.3.1.50 | | — | |
| >>Path Switch | M | | OCTET | Containing the | — | |
| Request | | | STRING | Path Switch | | |
| Acknowledge | | | | Request | | |
| Transfer | | | | Acknowledge | | |
| | | | | Transfer IE | | |
| | | | | specified in | | |
| | | | | subclause | | |
| | | | | 9.3.4.9. | | |
| >>PDU Session | O | | Expected UE | Expected UE | YES | ignore |
| Expected UE Activity | | | Activity | Activity | | |
| Behaviour | | | Behaviour | Behaviour for | | |
| | | | 9.3.1.94 | the PDU | | |
| | | | | Session. | | |
| PDU Session | | 0 . . . 1 | | | YES | ignore |
| Resource Released | | | | | | |
| List | | | | | | |
| >PDU Session | | 1 . . . | | | — | |
| Resource Released | | <maxnoofPDUSessions> | | | | |
| Item | | | | | | |
| >>PDU Session ID | M | | 9.3.1.50 | | — | |
| >>Path Switch | M | | OCTET | Containing the | — | |
| Request | | | STRING | Path Switch | | |
| Unsuccessful | | | | Request | | |
| Transfer | | | | Unsuccessful | | |
| | | | | Transfer IE | | |
| | | | | specified in | | |
| | | | | subclause | | |
| | | | | 9.3.4.20. | | |
| Allowed NSSAI | M | | 9.3.1.31 | Indicates the | YES | reject |
| | | | | S-NSSAIs | | |
| | | | | permitted by | | |
| | | | | the network. | | |
| Core Network | O | | 9.3.1.15 | | YES | ignore |
| Assistance | | | | | | |
| Information for RRC | | | | | | |
| INACTIVE | | | | | | |
| RRC Inactive | O | | 9.3.1.91 | | YES | ignore |
| Transition Report | | | | | | |
| Request | | | | | | |
| Criticality Diagnostics | O | | 9.3.1.3 | | YES | ignore |
| Redirection for Voice | O | | 9.3.1.116 | | YES | ignore |
| EPS Fallback | | | | | | |
| CN Assisted RAN | O | | 9.3.1.119 | | YES | ignore |
| Parameters Tuning | | | | | | |
| SRVCC Operation | O | | 9.3.1.128 | | YES | ignore |
| Possible | | | | | | |
| Enhanced Coverage | O | | 9.3.1.140 | | YES | ignore |
| Restriction | | | | | | |
| Extended Connected | O | | 9.3.3.31 | | YES | ignore |
| Time | | | | | | |
| UE Differentiation | O | | 9.3.1.144 | | YES | ignore |
| Information | | | | | | |
| NR V2X Services | O | | 9.3.1.146 | | YES | ignore |
| Authorized | | | | | | |
| LTE V2X Services | O | | 9.3.1.147 | | YES | ignore |
| Authorized | | | | | | |
| NR UE Sidelink | O | | 9.3.1.148 | This IE applies | YES | ignore |
| Aggregate Maximum | | | | only if the UE is | | |
| Bit Rate | | | | authorized for | | |
| | | | | NR V2X | | |
| | | | | services. | | |
| LTE UE Sidelink | O | | 9.3.1.149 | This IE applies | YES | ignore |
| Aggregate Maximum | | | | only if the UE is | | |
| Bit Rate | | | | authorized for | | |
| | | | | LTE V2X | | |
| | | | | services. | | |
| PC5 QoS Parameters | O | | 9.3.1.150 | This IE applies | YES | ignore |
| | | | | only if the UE is | | |
| | | | | authorized for | | |
| | | | | NR V2X | | |
| | | | | services. | | |
| CE-mode-B Restricted | O | | 9.3.1.155 | | YES | ignore |
| UE User Plane CIoT | O | | 9.3.1.160 | | YES | ignore |
| Support Indicator | | | | | | |
| UE Radio Capability ID | O | | 9.3.1.142 | | YES | reject |
| Management Based | O | | MDT PLMN List | | YES | ignore |
| MDT PLMN List | | | 9.3.1.168 | | | |
| Time Synchronisation | O | | 9.3.1.220 | | YES | ignore |
| Assistance | | | | | | |
| Information | | | | | | |
| 5G ProSe Authorized | O | | 9.3.1.233 | | YES | ignore |
| 5G ProSe UE PC5 | O | | NR UE Sidelink | This IE applies | YES | ignore |
| Aggregate Maximum | | | Aggregate | only if the UE is | | |
| Bit Rate | | | Maximum Bit | authorized for | | |
| | | | Rate | 5G ProSe | | |
| | | | 9.3.1.148 | services. | | |
| 5G ProSe PC5 QoS | O | | 9.3.1.234 | This IE applies | YES | ignore |
| Parameters | | | | only if the UE is | | |
| | | | | authorized for | | |
| | | | | 5G ProSe | | |
| | | | | services. | | |
| XR Traffic | O | | 9.3.1.X | | YES | ignore |
| Assistance | | | | | | |
| Information | | | | | | |

| Range bound | Explanation |
|---|---|
| maxnoofPDUSessions | Maximum no. of PDU sessions allowed |
| | towards one UE. Value is 256. |

### 9.3.1.X XR Traffic Assistance Information

This IE is used to indicate XR Traffic Assistance Information from the UE.

| | | | | |
|---|---|---|---|---|
| | | | IE Type and | Semantics |
| IE/Group Name | Presence | Range | Reference | Description |

| | | |
|---|---|---|
| XR capability | M | ENUMERATED |
| | | (true, . . .) |
| Traffic Assistance and | M | |
| Device information | | |
| >Jitter Information | O | ENUMERATED |
| | | (ms50, ms100, |
| | | ms200, ms300, |
| | | ms400, ms500, |
| | | ms600, |
| | | ms1000, |
| | | ms1500, |
| | | ms2000) |
| >Periodicity | M | ENUMERATED |
| | | (15 FPS, 30 |
| | | FPS, 45FPS, 60 |
| | | FPS, 72 FPS, |
| | | 90FPS, |
| | | 120FPS, . . .) |

### 9.3.4.9 Path Switch Request Acknowledge Transfer

This IE is transparent to the AMF.

| | | | IE type and | Semantics | | Assigned |
|---|---|---|---|---|---|---|
| IE/Group Name | Presence | Range | reference | description | Criticality | Criticality |
| UL NG-U UP TNL | O | | UP Transport | UPF endpoint of | — | |
| Information | | | Layer | the NG-U | | |
| | | | Information | transport bearer | | |
| | | | 9.3.2.2 | corresponding to | | |
| | | | | the DL NG-U UP | | |
| | | | | TNL Information | | |
| | | | | IE received in | | |
| | | | | the Path Switch | | |
| | | | | Request | | |
| | | | | Transfer IE. | | |
| Security Indication | O | | 9.3.1.27 | | — | |
| Additional NG-U UP | O | | UP Transport | NG-RAN node | YES | ignore |
| TNL Information | | | Layer | endpoint of the | | |
| | | | Information | NG-U transport | | |
| | | | Pair List | bearer indicated | | |
| | | | 9.3.2.11 | in the Path | | |
| | | | | Switch Request | | |
| | | | | Transfer IE and | | |
| | | | | the | | |
| | | | | corresponding | | |
| | | | | UPF endpoint for | | |
| | | | | split PDU | | |
| | | | | session. | | |
| Redundant UL NG-U | O | | UP Transport | UPF endpoint of | YES | ignore |
| UP TNL Information | | | Layer | the NG-U | | |
| | | | Information | transport | | |
| | | | 9.3.2.2 | bearer, for | | |
| | | | | delivery of UL | | |
| | | | | PDUs for the | | |
| | | | | redundant | | |
| | | | | transmission. | | |
| Additional Redundant | O | | UP Transport | NG-RAN node | YES | ignore |
| NG-U UP TNL | | | Layer | endpoint of the | | |
| Information | | | Information | NG-U transport | | |
| | | | Pair List | bearer for the | | |
| | | | 9.3.2.11 | redundant | | |
| | | | | transmission | | |
| | | | | indicated in the | | |
| | | | | Path Switch | | |
| | | | | Request | | |
| | | | | Transfer IE and | | |
| | | | | the | | |
| | | | | corresponding | | |
| | | | | UPF endpoint for | | |
| | | | | split PDU | | |
| | | | | session. | | |
| QoS Flow | | 0 . . . 1 | | | YES | ignore |
| Parameters List | | | | | | |
| >QoS Flow | | 1 . . . | | | — | |
| Parameters Item | | <maxnoofQoSFlows> | | | | |
| >>QoS Flow | M | | 9.3.1.51 | | — | |
| Identifier | | | | | | |
| >>Alternative QoS | O | | 9.3.1.151 | Indicates | — | |
| Parameters Set List | | | | alternative sets | | |
| | | | | of QoS | | |
| | | | | parameters for | | |
| | | | | the QoS flow. | | |
| >>CN Packet Delay | O | | Extended | Core Network | YES | ignore |
| Budget Downlink | | | Packet Delay | Packet Delay | | |
| | | | Budget | Budget is | | |
| | | | 9.3.1.135 | specified in TS | | |
| | | | | 23.501 [9]. | | |
| | | | | This IE may be | | |
| | | | | present in case | | |
| | | | | of GBR QoS | | |
| | | | | flows and is | | |
| | | | | ignored | | |
| | | | | otherwise. | | |
| >>CN Packet Delay | O | | Extended | Core Network | YES | ignore |
| Budget Uplink | | | Packet Delay | Packet Delay | | |
| | | | Budget | Budget is | | |
| | | | 9.3.1.135 | specified in TS | | |
| | | | | 23.501 [9]. | | |
| | | | | This IE may be | | |
| | | | | present in case | | |
| | | | | of GBR QoS | | |
| | | | | flows and is | | |
| | | | | ignored | | |
| | | | | otherwise. | | |
| >>Burst Arrival | O | | Burst Arrival | Indicates the | YES | ignore |
| Time Downlink | | | Time | downlink Burst | | |
| | | | 9.3.1.133 | Arrival Time of | | |
| | | | | the TSC QoS | | |
| | | | | flow | | |
| >>PDU Set QoS | O | | | | YES | ignore |
| parameters | | | | | | |
| >>>PDU Set | M | | Extended | This IE may be | | |
| Delay Budget UL | | | Packet Delay | present in case | | |
| | | | Budget | of GBR QoS | | |
| | | | 9.3.1.135 | flows and is | | |
| | | | | ignored | | |
| | | | | otherwise. | | |
| >>>PDU Set | M | | Extended | This IE may be | | |
| Delay Budget DL | | | Packet Delay | present in case | | |
| | | | Budget | of GBR QoS | | |
| | | | 9.3.1.135 | flows and is | | |
| | | | | ignored | | |
| | | | | otherwise. | | |
| >>>PDU Set | M | | Scalar and | Packet Error | | |
| Delay Budget | | | exponent | Rate is | | |
| | | | values | specified in | | |
| | | | | TS 23.501 | | |
| >>>PDU Set | O | | Enumerated(true, | Indicates not | | |
| Integration | | | . . . ) | all PDUs are | | |
| Indication | | | | needed to NG- | | |
| | | | | RAN, | | |

| Range bound | Explanation |
|---|---|
| maxnoofQoSFlows | Maximum no. of QoS flows allowed within one PDU session. Value is |
| | 64. |

### 9.3.4.5 PDU Session Resource Notify Transfer

This IE is transparent to the AMF.

| | | | IE type and | Semantics | | Assigned |
|---|---|---|---|---|---|---|
| IE/Group Name | Presence | Range | reference | description | Criticality | Criticality |
| QoS Flow Notify List | | 0 . . . 1 | | | — | |
| >QoS Flow Notify | | 1 . . . | | | — | |
| Item | | <maxnoofQoSFlows> | | | | |
| >>QoS Flow | M | | 9.3.1.51 | | — | |
| Identifier | | | | | | |
| >>Notification | M | | ENUMERATED | | — | |
| Cause | | | (fullfilled, not | | | |
| | | | fulfilled, . . . ) | | | |
| >>Current QoS | O | | Alternative | Index to the | YES | Ignore |
| Parameters Set | | | QoS | currently fulfilled | | |
| Index | | | Parameters | alternative QoS | | |
| | | | Set Notify | parameters set. | | |
| | | | Index | Value 0 | | |
| | | | 9.3.1.153 | indicates that | | |
| | | | | NG-RAN cannot | | |
| | | | | even fulfil the | | |
| | | | | lowest | | |
| | | | | alternative | | |
| | | | | parameters set. | | |
| QoS Flow Released | O | | QoS Flow List | | — | |
| List | | | with Cause | | | |
| | | | 9.3.1.13 | | | |
| Secondary RAT Usage | O | | 9.3.1.114 | | YES | ignore |
| Information | | | | | | |
| QoS Flow Feedback | | 0 . . . 1 | | | YES | ignore |
| List | | | | | | |
| >QoS Flow | | 1 . . . | | | — | |
| Feedback Item | | <maxnoofQoSFlows> | | | | |
| >>QoS Flow | M | | 9.3.1.51 | | — | |
| Identifier | | | | | | |
| >>Update Feedback | O | | BIT STRING | Each position in | — | |
| | | | {CN PDB DL(0), | the bitmap | | |
| | | | CN PDB UL(1)} | represents a | | |
| | | | (SIZE(8, . . . )) | QoS parameter. | | |
| | | | | If a bit is set to | | |
| | | | | “1”, the | | |
| | | | | respective | | |
| | | | | parameter was | | |
| | | | | not updated. | | |
| | | | | If a bit is set to | | |
| | | | | “0”, the | | |
| | | | | respective | | |
| | | | | parameter was | | |
| | | | | successfully | | |
| | | | | updated. | | |
| | | | | Bits 2-7 | | |
| | | | | reserved for | | |
| | | | | future use. | | |
| >>CN Packet Delay | O | | Extended | Indicates when | — | |
| Budget Downlink | | | Packet Delay | the packet delay | | |
| | | | Budget | budget downlink | | |
| | | | 9.3.1.135 | was not updated | | |
| | | | | in path switch | | |
| | | | | that NG-RAN | | |
| | | | | can offer this | | |
| | | | | value | | |
| >>CN Packet Delay | O | | Extended | Indicates when | — | |
| Budget Uplink | | | Packet Delay | the packet delay | | |
| | | | Budget | budget uplink | | |
| | | | 9.3.1.135 | was not updated | | |
| | | | | in path switch | | |
| | | | | that NG-RAN | | |
| | | | | can offer this | | |
| | | | | value | | |
| >>PDU Set QoS | O | | | | YES | ignore |
| parameters | | | | | | |
| >>>PDU Set | M | | Extended | This IE may be | | |
| Delay Budget UL | | | Packet Delay | present in case | | |
| | | | Budget | of GBR QoS | | |
| | | | 9.3.1.135 | flows and is | | |
| | | | | ignored | | |
| | | | | otherwise. | | |
| >>>PDU Set | M | | Extended | This IE may be | | |
| Delay Budget DL | | | Packet Delay | present in case | | |
| | | | Budget | of GBR QoS | | |
| | | | 9.3.1.135 | flows and is | | |
| | | | | ignored | | |
| | | | | otherwise. | | |
| >>>PDU Set | M | | Scalar and | Packet Error | | |
| Delay Budget | | | exponent | Rate is | | |
| | | | values | specified in TS | | |
| | | | | 23.501 | | |
| >>>PDU Set | O | | Enumerated(true, | Indicates not | | |
| Integration | | | . . . ) | all PDUs are | | |
| Indication | | | | needed to NG- | | |
| | | | | RAN, | | |

| Range bound | Explanation |
|---|---|
| maxnoofQoSFlows | Maximum no. of QoS flows allowed within one PDU session. Value is |
| | 64. |

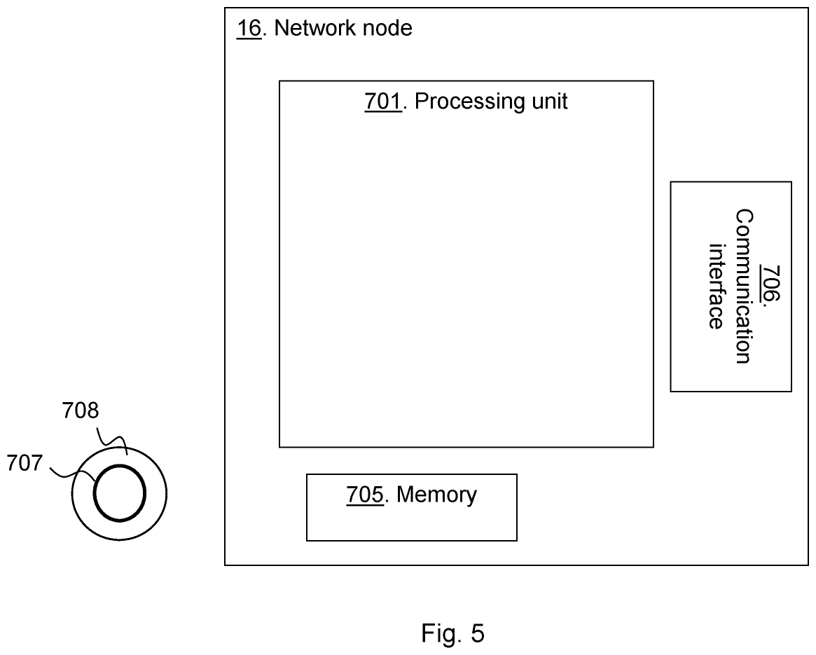

FIG. 5 is a block diagram depicting the network node 16, such as the AMF or SMF, for handling communication of the UE 10 in the communication network 1 according to embodiments herein.

The network node 16 may comprise processing circuitry 701, e.g. one or more processors, configured to perform the methods herein.

The network node 16 and/or the processing circuitry 701 may be configured to transmit the flag to the radio network node 130, such as the first radio network node 12, during a PDU Session setup procedure to indicate support of PDU Set handling.

The network node 16 and/or the processing circuitry 701 may be configured to receive the switch message, such as a N2 PATH SWITCH REQUEST message, from the radio network node 130 to establish a UE associated signalling connection to the 5GC. The switch message may further indicate one or more accepted XR QoS flows.

The network node 16 and/or the processing circuitry 701 is configured to transmit to the radio network node 130, the message with the one or more indications, wherein the first indication indicates one or more PDU Set QoS parameters which can be used by the radio network node 130 to replace one or more current parameters received from another radio network node; and/or the second indication indicates the UE XR Traffic Characteristic to be used for scheduling. The network node 16 and/or the processing circuitry 701 may be configured to transmit to, for example, the second radio network node 12, in the switch message such as a PATH SWITCH REQUEST ACKNOWLEDGE message, the indication of one or more PDU Set QoS parameters to use for the one or more accepted XR QoS flows. The one or more PDU Set QoS parameters may comprise PDU Set Delay Budget for UL and DL, PDU Set Error rate, and/or PDU Set Integration indication. Additionally, or alternatively, network node 16 and/or the processing circuitry 701 may be configured to signal one or more UE XR Traffic Characteristics to the second radio network node 13. The UE XR Traffic characteristics may include a periodicity and/or a jitter information that should be used by the radio network node 130 for the purpose of scheduling.

The network node 16 and/or the processing circuitry 701 may be configured to receive the support indication from the radio network node 130, wherein the support indication indicates supported PDU Set QoS parameter at the radio network node 130. Additionally, or alternatively, the network node 16 and/or the processing circuitry 701 may be configured to receive, e.g. in Path Switch Request, the accept indication from the radio network node 130 indicating that the radio network node 130 does or does not accept the one or more PDU Sets QoS parameters.

The network node 16 and/or the processing circuitry 701 may be configured to receive the flag from the radio network node 130 following a HO from a non-supporting radio network node, in, e.g., the PATH SWITCH REQUEST procedure. Upon reception of the flag, the network node 16 may consider that the QoS flow that are accepted are subject to PDU Set QoS handling and that the handover was done from a non supporting radio network node.

The network node 16 may comprise a memory 705. The memory 705 comprises one or more units to be used to store data on, such as data packets, indications, messages, support information, events and applications to perform the methods disclosed herein when being executed, and similar. Furthermore, the network node 16 may comprise a communication interface 706 such as comprising a transmitter, a receiver, a transceiver and/or one or more antennas.

The methods according to the embodiments described herein for the network node 16 are respectively implemented by means of e.g. a computer program product 707 or a computer program, comprising instructions, i.e., software code portions, which, when executed on at least one processor, cause the at least one processor to carry out the actions described herein, as performed by the network node 16. The computer program product 707 may be stored on a computer-readable storage medium 708, e.g., a disc, a universal serial bus (USB) stick or similar. The computer-readable storage medium 708, having stored thereon the computer program product, may comprise the instructions which, when executed on at least one processor, cause the at least one processor to carry out the actions described herein, as performed by the network node 16. In some embodiments, the computer-readable storage medium may be a transitory or a non-transitory computer-readable storage medium. Thus, embodiments herein may disclose the network node for handling communication of the UE in a communication network, wherein the network node comprises processing circuitry and a memory, said memory comprising instructions executable by said processing circuitry whereby said network node is operative to perform any of the methods herein.

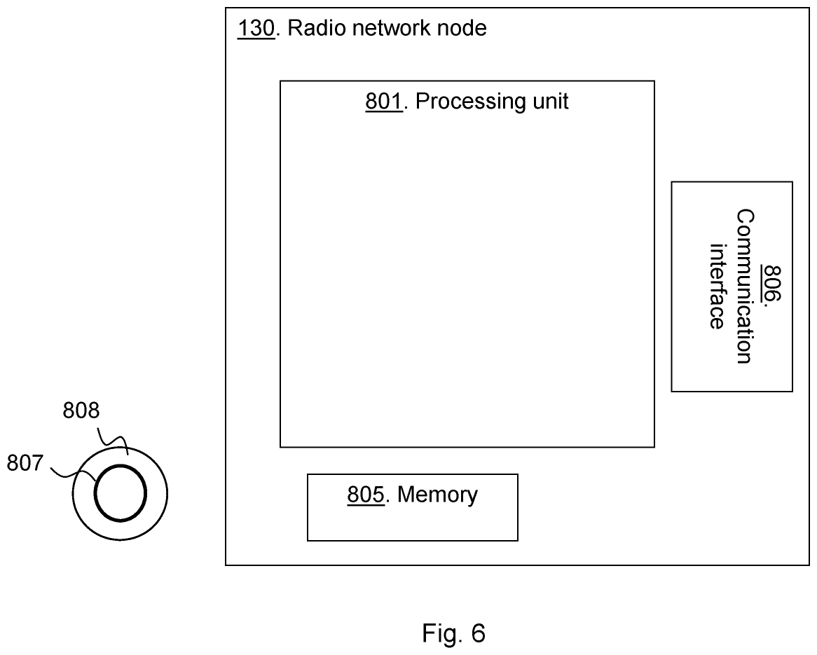

FIG. 6 is a block diagram depicting the radio network node 130, such as a first 12 or the second radio network node 13, for handling communication of the UE 10 in the communication network 1 according to embodiments herein.

The radio network node 130 may comprise processing circuitry 801, e.g. one or more processors, configured to perform the methods herein.

The radio network node 130 and/or the processing circuitry 801 may be configured to receive the flag from the network node 16 during a PDU Session setup procedure to indicate support of PDU Set handling. In case of support the radio network node 130 may reply with an acknowledgement message.

The radio network node 130 and/or the processing circuitry 801 may be configured to receive, during handover of the UE 10, the parameter indication that indicates one or more PDU Set QoS parameters to be used by the radio network node 130. The parameter indication can be over Xn signalling during a Xn-based handover, or over NG signalling during a NG-based Handover procedure.

The radio network node 130 and/or the processing circuitry 801 may be configured to transmit to the network node 16 the switch message, such as the N2 PATH SWITCH REQUEST message, to establish a UE associated signalling connection to the 5GC. The switch message may further indicate one or more accepted XR QoS flows.

The radio network node 130 and/or the processing circuitry 801 is configured to receive from the network node 16, the message with the one or more indications, wherein the first indication indicates one or more PDU Set QoS parameters which can be used by the radio network node 130 to replace one or more current parameters received from another radio network node; and/or the second indication indicates the UE XR Traffic Characteristic to be used for scheduling. As an example, the radio network node 130 and/or the processing circuitry 801 may be configured to receive from the network node 16, in the switch message, such as the PATH SWITCH REQUEST ACKNOWLEDGE message, the indication of one or more PDU Set QoS parameters to use for the one or more accepted XR QoS flows. The one or more PDU Set QoS parameters may comprise PDU Set Delay Budget for UL and DL, PDU Set Error rate, and/or PDU Set Integration indication. Additionally, or alternatively, radio network node and/or the processing circuitry 801 is configured to receive from the network node 16 UE XR Traffic Characteristics. The UE XR Traffic Characteristics may include a periodicity and/or a jitter information that should be used by the radio network node 130 for the purpose of scheduling.

The radio network node 130 and/or the processing circuitry 801 may be configured to determine whether to accept or not the indicated one or more PDU Set QoS parameters.

The radio network node 130 and/or the processing circuitry 801 may be configured to, when one or more PDU Set QoS related parameters are not accepted by the radio network node 130, use one or more previous PDU Set QoS parameters values received from the first radio network node 12.

The radio network node 130 and/or the processing circuitry 801 may be configured to transmit the support indication to the network node 16, wherein the support indication indicates supported PDU Set QoS parameter. The radio network node 130 and/or the processing circuitry 801 may be configured to signal, e.g. in Path Switch Request, the accept indication that the radio network node 130 does or does not accept the one or more PDU Sets QoS parameters via PATH SWITCH REQUEST ACKNOWLEDGE. The radio network node 130 and/or the processing circuitry 801 may be configured to signal the used PDU Set QoS parameters values in the PDU SESSION RESOURCE NOTIFY message to notify the network node 16.

The radio network node 130 and/or the processing circuitry 801 may be configured to transmit the flag to the network node 16 following a HO from a non-supporting radio network node, in, e.g., the PATH SWITCH REQUEST procedure.

The radio network node 130 may comprise a memory 805. The memory 805 comprises one or more units to be used to store data on, such as data packets, indications, messages, support of PDU sets of QoS parameters, further indications, information, events and applications to perform the methods disclosed herein when being executed, and similar. Furthermore, the radio network node 130 may comprise a communication interface 806 such as comprising a transmitter, a receiver, a transceiver and/or one or more antennas.

The methods according to the embodiments described herein for the radio network node 130 are respectively implemented by means of e.g. a computer program product 807 or a computer program, comprising instructions, i.e., software code portions, which, when executed on at least one processor, cause the at least one processor to carry out the actions described herein, as performed by the radio network node 130. The computer program product 807 may be stored on a computer-readable storage medium 808, e.g., a disc, a universal serial bus (USB) stick or similar. The computer-readable storage medium 808, having stored thereon the computer program product, may comprise the instructions which, when executed on at least one processor, cause the at least one processor to carry out the actions described herein, as performed by the radio network node 130. In some embodiments, the computer-readable storage medium may be a transitory or a non-transitory computer-readable storage medium. Thus, embodiments herein may disclose the radio network node for handling communication of the UE in a communication network, wherein the radio network node comprises processing circuitry and a memory, said memory comprising instructions executable by said processing circuitry whereby said radio network node is operative to perform any of the methods herein.

In some embodiments a more general term “network node” is used and it can correspond to any type of radio-network node or any network node, which communicates with a UE and/or with another network node.

In some embodiments the non-limiting term wireless device or user equipment (UE) is used and it refers to any type of wireless device communicating with a network node and/or with another wireless device in a cellular or mobile communication system. Examples of UE are target device, device to device (D2D) UE, proximity capable UE (aka ProSe UE), IoT capable device, machine type UE or UE capable of machine to machine (M2M) communication, Tablet, mobile terminals, smart phone, laptop embedded equipped (LEE), laptop mounted equipment (LME), USB dongles etc.

Embodiments are applicable to any RAT or multi-RAT systems, where the wireless device receives and/or transmit signals (e.g. data) e.g. NR, Wi-Fi, LTE, LTE-Advanced, Wideband Code Division Multiple Access (WCDMA), Global System for Mobile communications/enhanced Data rate for GSM Evolution (GSM/EDGE), Worldwide Interoperability for Microwave Access (WiMax), or Ultra Mobile Broadband (UMB), just to mention a few possible implementations.

As will be readily understood by those familiar with communications design, that functions means or circuits may be implemented using digital logic and/or one or more microcontrollers, microprocessors, or other digital hardware. In some embodiments, several or all of the various functions may be implemented together, such as in a single application-specific integrated circuit (ASIC), or in two or more separate devices with appropriate hardware and/or software interfaces between them. Several of the functions may be implemented on a processor shared with other functional components of a wireless device or network node, for example.

Alternatively, several of the functional elements of the processing means discussed may be provided through the use of dedicated hardware, while others are provided with hardware for executing software, in association with the appropriate software or firmware. Thus, the term “processor” or “controller” as used herein does not exclusively refer to hardware capable of executing software and may implicitly include, without limitation, digital signal processor (DSP) hardware and/or program or application data. Other hardware, conventional and/or custom, may also be included. Designers of communications devices will appreciate the cost, performance, and maintenance trade-offs inherent in these design choices.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

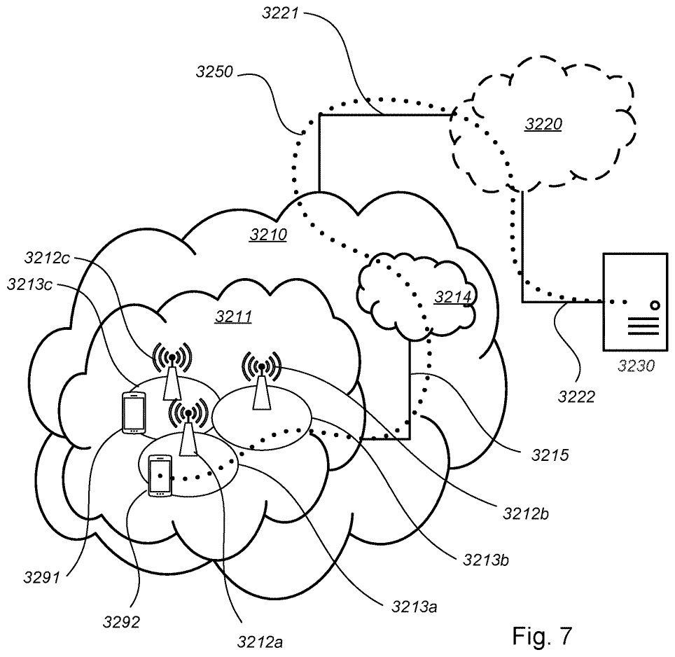

With reference to FIG. 7, in accordance with an embodiment, a communication system includes a telecommunication network 3210, such as a 3GPP-type cellular network, which comprises an access network 3211, such as a radio access network, and a core network 3214. The access network 3211 comprises a plurality of base stations 3212a, 3212b, 3212c, such as NBs, eNBs, gNBs or other types of wireless access points being examples of the radio network node 12 herein, each defining a corresponding coverage area 3213a, 3213b, 3213c. Each base station 3212a, 3212b, 3212c is connectable to the core network 3214 over a wired or wireless connection 3215. A first user equipment (UE) 3291, being an example of the UE 10, located in coverage area 3213c is configured to wirelessly connect to, or be paged by, the corresponding base station 3212c. A second UE 3292 in coverage area 3213a is wirelessly connectable to the corresponding base station 3212a. While a plurality of UEs 3291, 3292 are illustrated in this example, the disclosed embodiments are equally applicable to a situation where a sole UE is in the coverage area or where a sole UE is connecting to the corresponding base station 3212.

The telecommunication network 3210 is itself connected to a host computer 3230, which may be embodied in the hardware and/or software of a standalone server, a cloud-implemented server, a distributed server or as processing resources in a server farm. The host computer 3230 may be under the ownership or control of a service provider, or may be operated by the service provider or on behalf of the service provider. The connections 3221, 3222 between the telecommunication network 3210 and the host computer 3230 may extend directly from the core network 3214 to the host computer 3230 or may go via an optional intermediate network 3220. The intermediate network 3220 may be one of, or a combination of more than one of, a public, private or hosted network; the intermediate network 3220, if any, may be a backbone network or the Internet; in particular, the intermediate network 3220 may comprise two or more sub-networks (not shown).

The communication system of FIG. 7 as a whole enables connectivity between one of the connected UEs 3291, 3292 and the host computer 3230. The connectivity may be described as an over-the-top (OTT) connection 3250. The host computer 3230 and the connected UEs 3291, 3292 are configured to communicate data and/or signaling via the OTT connection 3250, using the access network 3211, the core network 3214, any intermediate network 3220 and possible further infrastructure (not shown) as intermediaries. The OTT connection 3250 may be transparent in the sense that the participating communication devices through which the OTT connection 3250 passes are unaware of routing of uplink and downlink communications. For example, a base station 3212 may not or need not be informed about the past routing of an incoming downlink communication with data originating from a host computer 3230 to be forwarded (e.g., handed over) to a connected UE 3291. Similarly, the base station 3212 need not be aware of the future routing of an outgoing uplink communication originating from the UE 3291 towards the host computer 3230.

In some embodiments, the telecommunication network 3210 includes one or more Open-RAN (ORAN) network nodes. An ORAN network node is a node in the telecommunication network 3210 that supports an ORAN specification (e.g., a specification published by the O-RAN Alliance, or any similar organization) and may operate alone or together with other nodes to implement one or more functionalities of any node in the telecommunication network 3210, including one or more network nodes and/or core network nodes.

Examples of an ORAN network node include an open radio unit (O-RU), an open distributed unit (O-DU), an open central unit (O-CU), including an O-CU control plane (O-CU-CP) or an O-CU user plane (O-CU-UP), a RAN intelligent controller (near-real time or non-real time) hosting software or software plug-ins, such as a near-real time control application (e.g., xApp) or a non-real time control application (e.g., rApp), or any combination thereof (the adjective “open” designating support of an ORAN specification). The network node may support a specification by, for example, supporting an interface defined by the ORAN specification, such as an A1, F1, W1, E1, E2, X2, Xn interface, an open fronthaul user plane interface, or an open fronthaul management plane interface. Moreover, an ORAN access node may be a logical node in a physical node. Furthermore, an ORAN network node may be implemented in a virtualization environment (described further below) in which one or more network functions are virtualized. For example, the virtualization environment may include an O-Cloud computing platform orchestrated by a Service Management and Orchestration Framework via an O-2 interface defined by the O-RAN Alliance or comparable technologies. The network nodes facilitate direct or indirect connection of user equipment (UE), such as by connecting UEs (one or more of which may be generally referred to as UEs 3291, 3292) to the core network over one or more wireless connections.

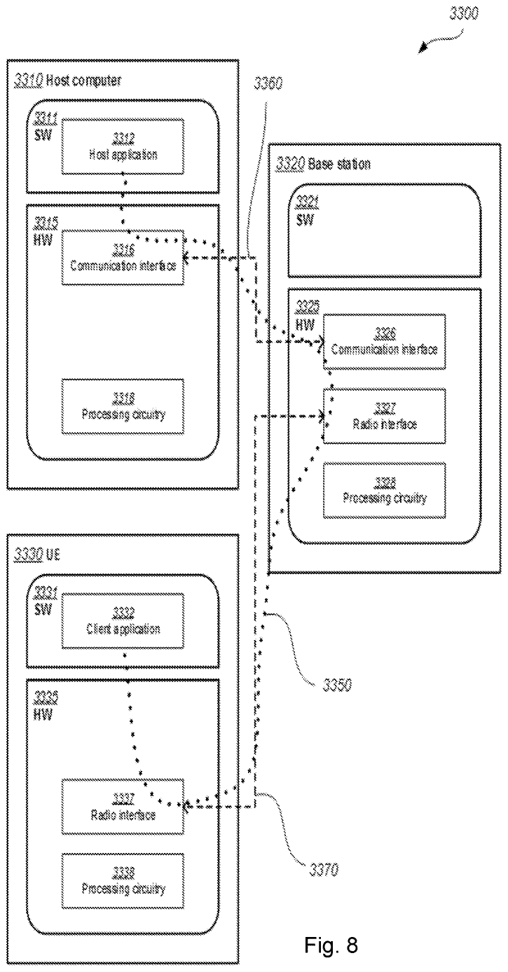

Example implementations, in accordance with an embodiment, of the UE, base station and host computer discussed in the preceding paragraphs will now be described with reference to FIG. 8. In a communication system 3300, a host computer 3310 comprises hardware 3315 including a communication interface 3316 configured to set up and maintain a wired or wireless connection with an interface of a different communication device of the communication system 3300. The host computer 3310 further comprises processing circuitry 3318, which may have storage and/or processing capabilities. In particular, the processing circuitry 3318 may comprise one or more programmable processors, application-specific integrated circuits, field programmable gate arrays or combinations of these (not shown) adapted to execute instructions. The host computer 3310 further comprises software 3311, which is stored in or accessible by the host computer 3310 and executable by the processing circuitry 3318. The software 3311 includes a host application 3312. The host application 3312 may be operable to provide a service to a remote user, such as a UE 3330 connecting via an OTT connection 3350 terminating at the UE 3330 and the host computer 3310. In providing the service to the remote user, the host application 3312 may provide user data which is transmitted using the OTT connection 3350.

The communication system 3300 further includes a base station 3320 provided in a telecommunication system and comprising hardware 3325 enabling it to communicate with the host computer 3310 and with the UE 3330. The hardware 3325 may include a communication interface 3326 for setting up and maintaining a wired or wireless connection with an interface of a different communication device of the communication system 3300, as well as a radio interface 3327 for setting up and maintaining at least a wireless connection 3370 with a UE 3330 located in a coverage area (not shown in FIG. 8) served by the base station 3320. The communication interface 3326 may be configured to facilitate a connection 3360 to the host computer 3310. The connection 3360 may be direct or it may pass through a core network (not shown in FIG. 8) of the telecommunication system and/or through one or more intermediate networks outside the telecommunication system. In the embodiment shown, the hardware 3325 of the base station 3320 further includes processing circuitry 3328, which may comprise one or more programmable processors, application-specific integrated circuits, field programmable gate arrays or combinations of these (not shown) adapted to execute instructions. The base station 3320 further has software 3321 stored internally or accessible via an external connection.

The communication system 3300 further includes the UE 3330 already referred to. Its hardware 3335 may include a radio interface 3337 configured to set up and maintain a wireless connection 3370 with a base station serving a coverage area in which the UE 3330 is currently located. The hardware 3335 of the UE 3330 further includes processing circuitry 3338, which may comprise one or more programmable processors, application-specific integrated circuits, field programmable gate arrays or combinations of these (not shown) adapted to execute instructions. The UE 3330 further comprises software 3331, which is stored in or accessible by the UE 3330 and executable by the processing circuitry 3338. The software 3331 includes a client application 3332. The client application 3332 may be operable to provide a service to a human or non-human user via the UE 3330, with the support of the host computer 3310. In the host computer 3310, an executing host application 3312 may communicate with the executing client application 3332 via the OTT connection 3350 terminating at the UE 3330 and the host computer 3310. In providing the service to the user, the client application 3332 may receive request data from the host application 3312 and provide user data in response to the request data. The OTT connection 3350 may transfer both the request data and the user data. The client application 3332 may interact with the user to generate the user data that it provides.

It is noted that the host computer 3310, base station 3320 and UE 3330 illustrated in FIG. 8 may be identical to the host computer 3230, one of the base stations 3212a, 3212b, 3212c and one of the UEs 3291, 3292 of FIG. 7, respectively. This is to say, the inner workings of these entities may be as shown in FIG. 8 and independently, the surrounding network topology may be that of FIG. 7.

In FIG. 8, the OTT connection 3350 has been drawn abstractly to illustrate the communication between the host computer 3310 and the user equipment 3330 via the base station 3320, without explicit reference to any intermediary devices and the precise routing of messages via these devices. Network infrastructure may determine the routing, which it may be configured to hide from the UE 3330 or from the service provider operating the host computer 3310, or both. While the OTT connection 3350 is active, the network infrastructure may further take decisions by which it dynamically changes the routing (e.g., on the basis of load balancing consideration or reconfiguration of the network).

The wireless connection 3370 between the UE 3330 and the base station 3320 is in accordance with the teachings of the embodiments described throughout this disclosure. One or more of the various embodiments improve the performance of OTT services provided to the UE 3330 using the OTT connection 3350, in which the wireless connection 3370 forms the last segment. More precisely, the teachings of these embodiments may improve the performance since embodiments herein provide improved performance at the UE and thereby provide benefits such as reduced user waiting time, longer battery time, and better responsiveness.

A measurement procedure may be provided for the purpose of monitoring data rate, latency and other factors on which the one or more embodiments improve. There may further be an optional network functionality for reconfiguring the OTT connection 3350 between the host computer 3310 and UE 3330, in response to variations in the measurement results. The measurement procedure and/or the network functionality for reconfiguring the OTT connection 3350 may be implemented in the software 3311 of the host computer 3310 or in the software 3331 of the UE 3330, or both. In embodiments, sensors (not shown) may be deployed in or in association with communication devices through which the OTT connection 3350 passes; the sensors may participate in the measurement procedure by supplying values of the monitored quantities exemplified above, or supplying values of other physical quantities from which software 3311, 3331 may compute or estimate the monitored quantities. The reconfiguring of the OTT connection 3350 may include message format, retransmission settings, preferred routing etc.; the reconfiguring need not affect the base station 3320, and it may be unknown or imperceptible to the base station 3320. Such procedures and functionalities may be known and practiced in the art. In certain embodiments, measurements may involve proprietary UE signaling facilitating the host computer's 3310 measurements of throughput, propagation times, latency and the like. The measurements may be implemented in that the software 3311, 3331 causes messages to be transmitted, in particular empty or ‘dummy’ messages, using the OTT connection 3350 while it monitors propagation times, errors etc.

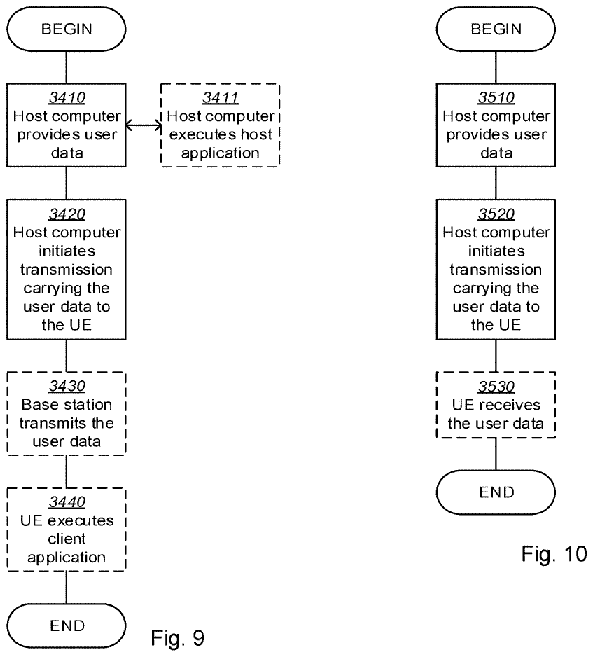

FIG. 9 is a flowchart illustrating a method implemented in a communication system, in accordance with one embodiment. The communication system includes a host computer, a base station and a UE which may be those described with reference to FIGS. 7 and 8. For simplicity of the present disclosure, only drawing references to FIG. 9 will be included in this section. In a first step 3410 of the method, the host computer provides user data. In an optional substep 3411 of the first step 3410, the host computer provides the user data by executing a host application. In a second step 3420, the host computer initiates a transmission carrying the user data to the UE. In an optional third step 3430, the base station transmits to the UE the user data which was carried in the transmission that the host computer initiated, in accordance with the teachings of the embodiments described throughout this disclosure. In an optional fourth step 3440, the UE executes a client application associated with the host application executed by the host computer.

FIG. 10 is a flowchart illustrating a method implemented in a communication system, in accordance with one embodiment. The communication system includes a host computer, a base station and a UE which may be those described with reference to FIGS. 7 and 8. For simplicity of the present disclosure, only drawing references to FIG. 10 will be included in this section. In a first step 3510 of the method, the host computer provides user data. In an optional substep (not shown) the host computer provides the user data by executing a host application. In a second step 3520, the host computer initiates a transmission carrying the user data to the UE. The transmission may pass via the base station, in accordance with the teachings of the embodiments described throughout this disclosure. In an optional third step 3530, the UE receives the user data carried in the transmission.

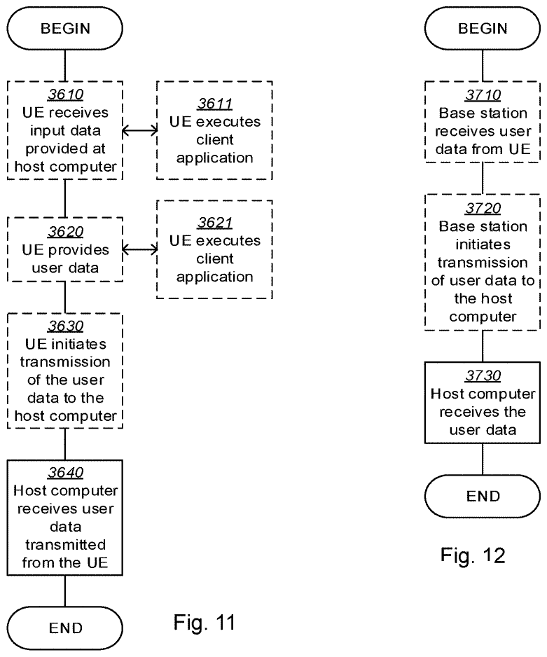

FIG. 11 is a flowchart illustrating a method implemented in a communication system, in accordance with one embodiment. The communication system includes a host computer, a base station and a UE which may be those described with reference to FIGS. 7 and 8. For simplicity of the present disclosure, only drawing references to FIG. 11 will be included in this section. In an optional first step 3610 of the method, the UE receives input data provided by the host computer. Additionally or alternatively, in an optional second step 3620, the UE provides user data. In an optional substep 3621 of the second step 3620, the UE provides the user data by executing a client application. In a further optional substep 3611 of the first step 3610, the UE executes a client application which provides the user data in reaction to the received input data provided by the host computer. In providing the user data, the executed client application may further consider user input received from the user. Regardless of the specific manner in which the user data was provided, the UE initiates, in an optional third substep 3630, transmission of the user data to the host computer. In a fourth step 3640 of the method, the host computer receives the user data transmitted from the UE, in accordance with the teachings of the embodiments described throughout this disclosure.

FIG. 12 is a flowchart illustrating a method implemented in a communication system, in accordance with one embodiment. The communication system includes a host computer, a base station and a UE which may be those described with reference to FIGS. 7 and 8. For simplicity of the present disclosure, only drawing references to FIG. 12 will be included in this section. In an optional first step 3710 of the method, in accordance with the teachings of the embodiments described throughout this disclosure, the base station receives user data from the UE. In an optional second step 3720, the base station initiates transmission of the received user data to the host computer. In a third step 3730, the host computer receives the user data carried in the transmission initiated by the base station.

It will be appreciated that the foregoing description and the accompanying drawings represent non-limiting examples of the methods and apparatus taught herein. As such, the apparatus and techniques taught herein are not limited by the foregoing description and accompanying drawings. Instead, the embodiments herein are limited only by the following claims and their legal equivalents.

| | |
|---|---|
| 5GC | 5G Core Network |
| AMF | Access and Mobility Management Function |
| NGAP | NG Application Protocol |
| NG-C | NG Control Plane |
| RAN | Radio Access Network |
| RAT | Radio Access Technology |
| UE | User Equipment |
| PSDB | PDU Set Delay Budget |
| XR | extended Reality |

### EMBODIMENTS

### Embodiment A1

A method performed by a network node for handling communication of a UE in a communication network, the method comprising
transmitting to a radio network node, a message with one or more indications, wherein a first indication indicates one or more PDU Set QoS Parameters which can be used by the radio network node to replace one or more current parameters received from another radio network node; and/or a second indication indicates a UE XR Traffic Characteristics to be used for scheduling.

### Embodiment A2

The method according to embodiment A1, further comprising
transmitting a flag to the radio network node during a PDU Session setup procedure to indicate support of PDU Set handling.

### Embodiment A3

The method according to any of the embodiments A1-A2, further comprising
receiving a switch message, from the radio network node to establish a UE associated signalling connection to the 5GC.

### Embodiment A4

The method according to any of the embodiments A1-A3, wherein the one or more PDU Set QoS parameters comprises PDU Set Delay Budget for UL and DL, PDU Set Error rate, and/or PDU Set Integration indication, and/or the UE XR Traffic characteristics comprises a periodicity and/or a jitter information that should be used by the radio network node for the purpose of scheduling.

### Embodiment A5

The method according to any of the embodiments A1-A4, further comprising
receiving an indication from the radio network node, wherein the indication indicates supported PDU Set QoS parameter at the radio network node, and/or an indication that the radio network node does or does not accept the one or more PDU Sets QoS parameters.

### Embodiment A6

The method according to any of the embodiments A1-A5, further comprising
receiving a flag from the radio network node following a HO from a non-supporting gNB, and upon reception of the flag, the network node considers that the QoS flow that is accepted is subject to PDU Set QoS handling and that the handover was done from a non supporting source radio network node.

### Embodiment B1

A method performed by a radio network node for handling communication of a UE in a communication network, the method comprising
receiving to a radio network node, a message with one or more indications, wherein a first indication indicates one or more PDU Set QoS Parameters which can be used by the radio network node to replace one or more current parameters received from another radio network node; and/or a second indication indicates a UE XR Traffic Characteristics to be used for scheduling.

### Embodiment B2

The method according to embodiment B1, further comprising
receiving a flag from the network node during a PDU Session setup procedure to indicate support of PDU Set handling.

### Embodiment B3

The method according to any of the embodiments B1-B2, further comprising
receiving, during handover of the UE 10, an indication that indicates one or more PDU Set QoS parameters to be used by the second radio network node 13.

### Embodiment B4

The method according to any of the embodiments B1-B3, further comprising
transmitting to the network node, a switch message to establish a UE associated signalling connection to the 5GC.

### Embodiment B5

The method according to any of the embodiments B1-B4, wherein the one or more PDU Set QoS parameters comprises PDU Set Delay Budget for UL and DL, PDU Set Error rate, and/or PDU Set Integration indication, and/or the UE XR Traffic characteristics comprises a periodicity and/or a jitter information that should be used by the radio network node for the purpose of scheduling.

### Embodiment B6

The method according to any of the embodiments B1-B5, further comprising
determining whether to accept or not the indicated one or more PDU Set QoS parameters.

### Embodiment B7

The method according to any of the embodiments B1-B6, further comprising, when one or more PDU Set QoS related parameters are not accepted by the second radio network node 13, using one or more previous PDU Set QoS parameters values received from the first radio network node 12.

### Embodiment B8

The method according to any of the embodiments B1-B7, further comprising
transmitting an indication to the network node 16, wherein the indication indicates supported PDU Set QoS parameter; and/or an indication that it does or does not accept the one or more PDU Sets QoS parameters via PATH SWITCH REQUEST ACKNOWLEDGE.

### Embodiment B9

The method according to any of the embodiments B1-B8, further comprising transmitting a flag to the network node following a HO from a non-supporting gNB.

### Embodiment C1

A network node for handling communication of a UE in a communication network, wherein the network node is configured to:
transmit to a radio network node, a message with one or more indications, wherein a first indication indicates one or more PDU Set QoS Parameters which can be used by the radio network node to replace one or more current parameters received from another radio network node; and/or a second indication indicates a UE XR Traffic Characteristics to be used for scheduling.

### Embodiment D1

A radio network node for handling communication of a UE in a communication network, wherein the radio network node is configured to
receive from a network node, a message with one or more indications, wherein a first indication indicates one or more PDU Set QoS Parameters which can be used by the radio network node to replace one or more current parameters received from another radio network node; and/or a second indication indicates a UE XR Traffic Characteristics to be used for scheduling.

1-34. (canceled)

35. A method performed by a network node for handling communication of a user equipment (UE) in a communication network, the method comprising:
transmitting to a radio network node, a message with one or more indications, wherein a first indication indicates one or more protocol data unit (PDU) Set Quality of Service (QoS) parameters, which can be used by the radio network node to replace one or more current parameters received from another radio network node for the UE, and/or a second indication indicates a UE extended reality (XR) Traffic Characteristic to be used for scheduling resources for the UE.

36. The method according to claim 35, further comprising transmitting a flag to the radio network node during a PDU Session setup procedure to indicate support of PDU Set handling.

37. The method according to claim 35, further comprising receiving a switch message, from the radio network node to establish a UE associated signaling connection to a 5G core (5GC).

38. The method according to claim 35, wherein the one or more PDU Set Qos parameters comprises PDU Set Delay Budget for uplink (UL) and downlink (DL) PDU Set Error rate, and/or PDU Set Integration indication, and/or the UE XR Traffic characteristic comprises a periodicity and/or a jitter information that should be used by the radio network node for the purpose of scheduling.

39. The method according to claim 35, further comprising receiving a support indication from the radio network node, wherein the support indication indicates supported PDU Set QoS parameter at the radio network node, and/or an accept indication that the radio network node does or does not accept the one or more PDU Sets QoS parameters.

40. The method according to claim 35, further comprising receiving a flag from the radio network node following a handover (HO) from a non-supporting radio network node, and upon reception of the flag, the network node considers that the QoS flow that is accepted is subject to PDU Set QoS handling and that the handover was done from a non-supporting radio network node.

41. A method performed by a radio network node for handling communication of a user equipment (UE) in a communication network, the method comprising:
receiving from a network node, a message with one or more indications, wherein a first indication indicates one or more protocol data unit (PDU) Set Quality of Service (QoS) parameters, which can be used by the radio network node to replace one or more current parameters received from another radio network node for the UE, and/or a second indication indicates a UE extended reality (XR) Traffic Characteristic to be used for scheduling resources for the UE.

42. The method according to claim 41, further comprising receiving a flag from the network node during a PDU Session setup procedure to indicate support of PDU Set handling.

43. The method according to claim 41, further comprising receiving, during handover of the UE, a parameter indication that indicates one or more PDU Set QoS parameters to be used by the radio network node.

44. The method according to claim 41, further comprising transmitting to the network node, a switch message to establish a UE associated signaling connection to a 5G core (5GC).

45. The method according to claim 41, wherein the one or more PDU Set Qos parameters comprises PDU Set Delay Budget for uplink (UL) and downlink (DL) PDU Set Error rate, and/or PDU Set Integration indication, and/or the UE XR Traffic characteristic comprises a periodicity and/or a jitter information that should be used by the radio network node for the purpose of scheduling.

46. The method according to claim 41, further comprising determining whether to accept or not the indicated one or more PDU Set QoS parameters.

47. The method according to claim 41, further comprising, when one or more PDU Set QoS related parameters are not accepted by the radio network node, using one or more previous PDU Set QoS parameters values received from a first radio network node.

48. The method according to claim 41, further comprising transmitting a support indication to the network node, wherein the support indication indicates supported PDU Set Qos parameter and/or an accept indication that the radio network node does or does not accept the one or more PDU Sets QoS parameters via PATH SWITCH REQUEST ACKNOWLEDGE.

49. The method according to claim 41, further comprising transmitting a flag to the network node following a handover (HO) from a non-supporting radio network node.

50. A network node configured to handle communication of a user equipment (UE) in a communication network, wherein the network node comprises:
a communication interface; and
processing circuitry configured to transmit, via the communication interface, a message with one or more indications to a radio network node, wherein a first indication indicates one or more protocol data unit (PDU) Set Quality of Service, QoS, parameters, which can be used by the radio network node to replace one or more current parameters received from another radio network node for the UE, and/or a second indication indicates a UE extended reality (XR) Traffic Characteristic to be used for scheduling resources for the UE.

51. The network node according to claim 50, wherein the processing circuitry is further configured to transmit, via the communication interface, a flag to the radio network node during a PDU Session setup procedure to indicate support of PDU Set handling.

52. The network node according to claim 50, wherein the processing circuitry is configured to receive, via the communication interface, a switch message, from the radio network node to establish a UE associated signaling connection to a 5G core (5GC).

53. The network node according to claim 50, wherein the one or more PDU Set QoS parameters comprises PDU Set Delay Budget for uplink (UL) and downlink (DL) PDU Set Error rate, and/or PDU Set Integration indication, and/or the UE XR Traffic characteristic comprises a periodicity and/or a jitter information that should be used by the radio network node for the purpose of scheduling.

54. A radio network node configured for handling communication of a user equipment (UE) in a communication network, wherein the radio network node comprises:
a communication interface; and
processing circuitry configured to receive, via the communication interface, a message from a network node, the message having one or more indications and wherein a first indication indicates one or more protocol data unit (PDU) Set Quality of Service (QoS) parameters, which can be used by the radio network node to replace one or more current parameters received from another radio network node for the UE, and/or a second indication indicates a UE extended reality (XR) Traffic Characteristic to be used for scheduling resources for the UE.
